(19) United States
(12) Patent Application Publication
(10) Pub. No.: US 2008/0239485 A1
(43) Pub. Date: Oct. 2, 2008

(54) METHOD FOR MANUFACTURING STEREOSCOPIC DISPLAYING APPARATUS, METHOD FOR MANUFACTURING PHASE SHIFT PLATE, AND THE PHASE SHIFT PLATE THEREBY

(75) Inventors: MIKIO KURODA, NIIGATA (JP); TATSUYA SATO, NIIGATA (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ARISAWA MFG. CO., LTD., NIIGATA (JP)

(21) Appl. No.: 11/693,726

(22) Filed: Mar. 30, 2007

(51) Int. Cl. G02B 5/30; H01J 9/00

(52) U.S. Cl. 359/485; 445/24

(57) ABSTRACT

A method for manufacturing a stereoscopic displaying apparatus is provided. The method for manufacturing a stereoscopic displaying apparatus including: an image displaying section that has an image generating section including a right eye image generating region on which a right eye image is generated and a left eye image generating region on which a left eye image is generated and emits a right eye image light including the right eye image and a left eye image light including the left eye image as linear polarized lights of which polarization axes are in parallel with each other; and a phase shift plate having a first polarizing region and a second polarizing region, when the right eye image light is incident on the first polarizing region and the left eye image light is incident on the second polarizing region, respectively, that emits the incident right eye image light and left image light as linear polarized lights of which polarization axes are orthogonalized to each other or circularly polarized lights of which polarization axes are rotated in the directions opposite to each other. The method for manufacturing the stereoscopic displaying apparatus includes: arranging the first polarizing region and the second polarizing region adjacent to each other on the phase shift plate; providing a light blocking section that blocks the incident right eye image light and left eye image light: on the boundary between the first polarizing region and the second polarizing region of one surface of the phase shift plate; and attaching to the image displaying section the phase shift plate such that one surface of phase shift plate on which the light blocking section is provided faces the image displaying section. The step of attaching the phase shift plate to the image displaying section includes adhering a periphery outside the regions on which the phase shift plate is provided, which is one surface of the image displaying section from which the right eye image light and the left eye image light are emitted to a side surface adjacent to the incident surface of the phase shift plate on which the right eye image light and the left eye image light are incident with adhesive.

### BACKGROUND

1. Technical Field

The present invention relates to a method for manufacturing a stereoscopic displaying apparatus, a method for manufacturing a phase shift plate for use in the stereoscopic displaying apparatus, and the phase shift plate. Particularly, the present invention relates to a method for manufacturing a stereoscopic displaying apparatus that displays a stereoscopic image by projecting a right eye image and a left eye image onto a viewer.

2. Related Art

A stereoscopic displaying apparatus has been known, which has an image displaying section that displays a right eye image and a left eye image on regions different from each other and a phase shift plate arranged facing the two different regions and having two different regions on which the polarization axes of incident lights are orthogonalized to each other and projects a parallactic image onto a viewer as for example, in Japanese Patent Application Publication No. 2006-284873.

Viewing with an angle of field from a position at the center of the vertical direction of the stereoscopic displaying apparatus, cross talk may occur such that a part of the right eye image generated by a liquid-crystal display panel is transmitted to the left eye of the viewer through a quarter wave retarder for the left eye.

### SUMMARY

Accordingly, it is an advantage of the invention to provide a method for manufacturing a stereoscopic displaying apparatus which is capable of solving the above-mentioned problem. This advantage may be achieved through the combination of features described in independent claims of the invention. Dependent claims thereof specify preferable embodiments of the invention.

Thus, a first aspect of the present invention provides a method for manufacturing a stereoscopic displaying apparatus. The stereoscopic displaying apparatus includes: an image displaying section that has an image generating section including a right eye image generating region on which a right eye image is generated and a left eye image generating region on which a left eye image is generated and emits a right eye image light including the right eye image and a left eye image light including the left eye image as linear polarized lights of which polarization, axes are in parallel with each other; and a phase shift plate having a first polarizing region and a second polarizing region when the right eye image light is incident on the first polarizing region and the left eye image light is incident on the second polarizing region, respectively, that emits the incident right eye image light and left image light as linear polarized lights of which polarization axes are orthogonalized to each other or circularly polarized lights of which polarization axes are rotated in the directions opposite to each other. The method for manufacturing a stereoscopic displaying apparatus includes the steps of: arranging the first polarizing region and the second polarizing region adjacent to each other on the phase shift plate; providing a light blocking section that blocks the incident right eye image light and left eye image light on the boundary between the first polarizing region and the second polarizing region of one surface of the phase shift plate; and attaching to the image displaying section the phase shift plate such that one surface of phase shift plate on which the light blocking section is provided faces the image displaying section. The step of attaching the phase shift plate to the image displaying section includes adhering a periphery outside the regions on which the phase shift plate is provided, which is one surface of the image displaying section from which the right eye image light and the left eye image light are emitted to a side surface adjacent to the incident surface of the phase shift plate on which the light eye image light and the left eye image light are incident with adhesive.

In the method for manufacturing a stereoscopic displaying apparatus, it is preferred that the periphery of the image displaying section and the side surface of the phase shift plate are adhered at a plurality of adhering positions separated from each other with adhesive. Moreover, in the method for manufacturing a stereoscopic displaying apparatus, it is more preferred that the surface of the image displaying section from which the right eye image light and the left eye image light are emitted and the surface of the phase shift plate on which the light blocking section is provided are adhered in contact with each other.

A second aspect of the present invention provides a method for manufacturing a phase shift plate for use in the stereoscopic displaying apparatus that displays a stereoscopic image to a viewer.

The method includes: arranging a first polarizing region and a second polarizing region adjacent to each other from which incident linear polarized lights of which realization axes are in parallel with each other are emitted as linear polarized lights of which polarization axes are orthogonalized to each other or circularly polarized lights of which polarization axes are rotated in the directions opposite to each other; and providing a light blocking section that blocks the incident linear polarized lights or circularly polarized lights on the boundary between the first polarizing region and the second polarizing region on one surface of the phase shift plate.

A third aspect of the present invention provides a phase shift plate for used in the stereoscopic displaying apparatus that displays a stereoscopic image to a viewer. The phase shift plate includes: a first polarizing region and a second polarizing region adjacent to each other from which incident linear polarized lights of which polarization axes are in parallel with each other are emitted as linear polarized lights of which polarization axes are orthogonalized to each other or circularly polarized lights of which polarization axes are rotated in the directions opposite to each other; and a light blocking section that blocks the incident linear polarized lights or circularly polarized lights on the boundary between the first polarizing region and the second polarizing region on one surface of the phase shift plate.

Here, all necessary features of the present invention are not listed in the summary of the invention. The sub-combinations of the features may become the invention.

### BRIEF DESCRIPTION OF THE DRAWINGS

FIG. 1 is an exploded perspective view showing a stereoscopic displaying apparatus 100 manufactured by a method according to an embodiment;

FIG. 2 is a schematic diagram showing a usage state of the stereoscopic displaying apparatus 100;

FIG. 3 is a schematic cross-sectional view showing a phase shift plate 180 at a time when the first step of the method for manufacturing the stereoscopic displaying apparatus 100 is completed;

FIG. 4 is a schematic cross-sectional view showing a phase shift plate 180 at a time when the second step of the method for manufacturing the stereoscopic displaying apparatus 100 is completed;

FIG. 5 is a schematic cross-sectional view showing a housing 110, a light source 120, an image displaying section 130 and the phase shift plate 180 at a time when the third step of the method for manufacturing the stereoscopic displaying apparatus 100 is completed;

FIG. 6 is a schematic plan view showing the stereoscopic displaying apparatus 100 manufactured after the third step of the method for manufacturing the stereoscopic displaying apparatus 100 is completed;

FIG. 7 is a schematic cross-sectional view showing the image displaying section 130 and the phase shift plate 180 at a time when the third step of the method for manufacturing the stereoscopic displaying apparatus 100 is completed;

FIG. 8 is a schematic cross-sectional view showing the housing 110, the light source 120, the image displaying section 130 and the phase shift plate 180 at a time when the fourth step of the method for manufacturing the stereoscopic displaying apparatus 100 is completed;

FIG. 9 is an exploded perspective view showing another stereoscopic displaying apparatus 101 manufactured by the method according to an embodiment.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

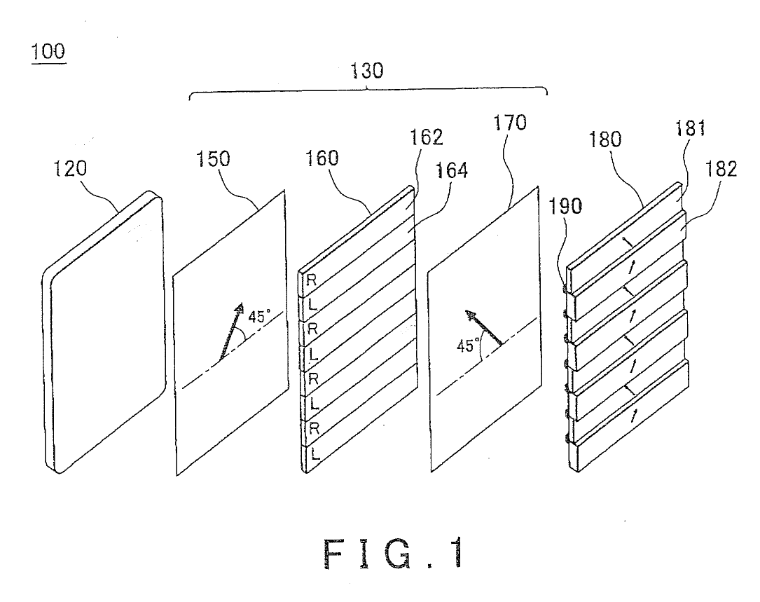

FIG. 1 is an exploded perspective view showing a stereoscopic displaying apparatus 100 manufactured by a method according to the present embodiment. As shown in FIG. 1, the stereoscopic displaying apparatus 100 includes alight source 120, an image displaying section 130 and a phase shift plate 180 in the described order, and those are accommodated in a housing 110 described later. The image displaying section 130 includes a polarizing plate 150, an image generating section 160 and a polarizing plate 170. A viewer 500 described later views a stereoscopic image displayed on the stereoscopic displaying apparatus 100 from the right side of the phase shift plate 180 shown in FIG. 1.

The light source 120 is arranged on the innermost of the stereoscopic displaying apparatus 100 from the viewpoint of the viewer 500 and emits a white non-polarized light to one surface of the polarizing plate 150 in using the stereoscopic displaying apparatus 100. Here, the light source 120 is a surface illuminant in the present embodiment, however, the light source 120 may be a combination of such as a point light source and a condenser lens instead of the surface illuminant.

An example of condenser lens is a Fresnel lens.

The polarizing plate 150 is provided on the image generating section 160 on the light source 120 side. The polarizing plate 150 has a transmission axis and a absorption axis orthogonalized to the transmission axis, and when non-polarized light emitted from the light source 120 is incident thereon, transmits light having the polarization axis in parallel with the transmission axis direction among the non-polarized light but blocks light having the polarization axis in parallel with the absorption axis direction.

Here, the polarization axis direction is a direction to which light oscillates in the electric field. The transmission axis direction of the polarizing plate 150 is the direction toward the upper right having the angle of 45 degree with the horizontal direction when the viewer 500 views the stereoscopic displaying apparatus 100 shown as an arrow in FIG. 1.

The image generating section 160 has right eye image generating regions 162 and left eye image generating regions 164.

Each of the right eye image generating regions 162 and the left eye image generating regions 164 are obtained by dividing the image generating section 160 by the horizontal direction, and a plurality of right eye image generating regions 162 and left eye image generating regions 162 are alternately arranged in the vertical direction as shown in FIG. 1. In addition, an exterior frame 165 described later is provided on the periphery of the image generating section 160 (not shown in the figure), and the right eye image generating regions 162 and the left eye image generating regions 164 are supported by the exterior frame 165 in the image generating section 160.

In using the stereoscopic displaying apparatus 100, a right eye image is generated in each right eye image generating region 162 and a left eye image is generated in each left eye image generating region 164 in the image generating section 160, respectively. At this time, light transmitted through the polarizing plate 150 is incident on the right eye image generating region 162 and the left eye image generating region 164 in the image generating section 160, and then, the light transmitted through the right eye image generating region 162 becomes an image light of the right eye image (hereinafter referred to as a right eye image light) and the light transmitted through the left eye image generating region 164 becomes an image light of the left eye image (hereinafter referred to as a left eye image light).

Here, each of the right eye image light transmitted through the right eye image generating region 162 and the left eye image light transmitted through the left eye image generating region 164 are linear polarized light having the polarization axis in a specified direction. Here, each of the polarization axis in the specified direction may be in the same direction each other. For example, each polarization axis is in the same direction as that of the transmission axis of the polarizing plate 170 described later.

In such image generating section 160, a plurality of small cells are arranged in a matrix in a plane in the horizontal direction and the vertical direction, for example, and a LCD (liquid crystal display) in which liquid crystal is sealed in each cell sandwiched between the oriented films is used. Each cell is electrically driven in the LCD, so that each cell switches between a state that the light is transmitted therethrough without changing the direction of the polarization axis and a state that the light is transmitted therethrough with rotating the direction of the polarization axis by 90 degree.

The polarizing plate 170 is provided in the image generating section 160 on the viewer 500 side. When the right eye image light transmitted through the right eye image generating region 162 and the left eye image light transmitted through the left eye image generating region 164 are incident thereon, the polarizing plate 170 transmits the light of which polarization axis is in parallel with the transmission axis but blocks the light of which polarization axis is in parallel with the absorption axis among the incident lights. Here, the direction of the transmission axis of the polarizing plate 170 is 45 degree upper left direction from the horizontal direction when the viewer 500 views the stereoscopic image display section 100 shown as the arrow in FIG. 1.

The phase shift plate 180 includes first polarizing regions 181 and second polarizing regions 182. The size and the position for each of the first polarizing regions 181 and each of the second polarizing regions 182 in the phase shift plate 180 are corresponding to those of the right eye image generating region 162 and the left eye image generating region 164 in the image generating section 160 as shown in FIG. 1. Therefore, in using the stereoscopic displaying apparatus 100, the right eye image light transmitted through the right eye image generating region 162 is incident on the first polarizing region 181 and the left eye image light transmitted through the left eye image generating region 164 is incident on the second polarizing region 182. In addition, a light blocking section 190 is provided on each boundary between the first polarizing regions 181 and the second polarizing regions 182 on the surface facing the image displaying section 130 of the phase shift plate 180. The light blocking section 190 absorbs and blocks the image light over the boundary and incident on the first polarizing region 181 among the left eye image light to be incident on the second polarizing region 182 adjacent to the first polarizing region 181 in the phase shift plate 180. In the same way, the light blocking section 190 absorbs and blocks the image light over the boundary and incident on the second polarizing region 182 among the right eye image light to be incident on the first polarizing region 181 adjacent to the second polarizing region 182 in the phase shift plate 180. Thus, the light blocking section 190 is provided on each boundary on the phase shift plate 180, so that cross talk is less likely to occur in the right eye image light and the left eye image light emitted from the stereoscopic displaying apparatus 100.

The first polarizing region 181 does not rotate the polarization axis of the incident right eye image light but directly transmits therethrough. Meanwhile, the second polarizing region 182 rotates the polarization axis of the incident left eye image light to the direction orthogonalized to the polarization axis of the right eye image light incident on the first polarizing region 181. Therefore, the direction of the polarization axis of the right eye image light transmitted through the first polarizing region 181 and that of the polarization axis of the left eye image light transmitted through the second polarizing region 182 are orthogonalized to each other shown as the arrows in FIG. 1. Here, the arrows of the phase shift plate 180 shown in FIG. 1 indicate the polarization axes of the polarized light transmitted through the phase shift plate 180. A transparent glass or resin is used for each first polarizing region 181, and a half wave retarder having an optical axis having the angle of 45 degree with the direction of the polarization axis of the incident left eye image light is used for each second polarizing region 182, for example. The direction of the optical axis of the second polarizing region 182 is the horizontal direction or the vertical direction in the embodiment shown in FIG. 1. Here, the optical axis means either the phase advance axis or the phase delay axis when light is transmitted through the second polarizing region 182.

In addition, the stereoscopic displaying apparatus 100 may have a diffuser panel that diffuses the right eye image light and the left eye image light transmitted through the first polarizing region 181 and the second polarizing region 182 in at least one direction of the horizontal direction or the vertical direction on the viewer 500 side, i.e. the right side of the phase shift plate 180 in FIG. 1. For such diffuser panel, a lenticular lens sheet on which plurality of convex lenses (cylindrical lenses) are extended in the horizontal direction or the vertical direction, or a lens array sheet on which a plurality of convex lenses are arranged on a plane is used, for example.

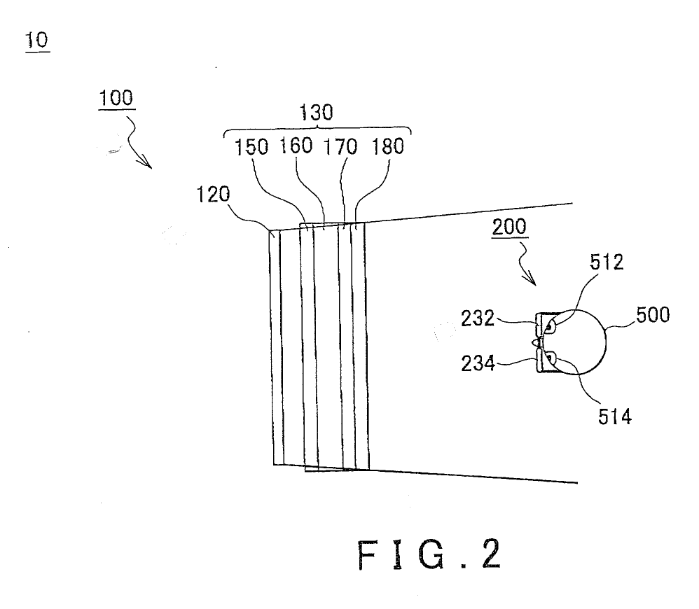

FIG. 2 is a schematic diagram showing a usage state of the stereoscopic displaying apparatus 100. Viewing a stereoscopic image through the stereoscopic displaying apparatus 100, the viewer 500 views the right eye image light and the left eye image light projected from the stereoscopic displaying apparatus 100 with a polarized glasses 200 as shown in FIG. 2. When the viewer 500 wears the polarized glasses 200, a right eye image transmitting section 232 is disposed at the position for a right eye 512 side and a left eye image transmitting section 234 is disposed at the position for a left eye 514 side of the viewer 500. Each of the right eye image transmitting section 232 and the left eye image transmitting section 234 is a polarizing lens having a specified transmission axis direction different from each other and fixed to a frame of the polarized glasses 200.

The right eye image transmitting section 232 is a polarizing plate of which transmission axis direction is the same as that of the right eye image light transmitted through the first polarizing region 181 and of which absorption axis direction is orthogonalized to the transmission axis direction. Meanwhile, the left eye image transmitting section 234 is a polarizing plate of which transmission axis direction is the same as that of the left eye image light transmitted through the second polarizing region 182 and of which absorption axis direction is orthogonalized to the transmission axis direction. For each of the right eye image transmitting section 232 and the left eye image transmitting section 234, a polarizing lens to which a polarizing film obtained by uniaxially drawing a film impregnating dichromatic dye is attached is used, for example.

Viewing a stereoscopic image through the stereoscopic displaying apparatus 100, the viewer 500 views the stereoscopic displaying apparatus 100 with the polarized glasses 200 as described above within a range in which the right eye image light and the left eye image light transmitted through the first polarizing region 181 and the second polarizing region 182, respectively in the phase shift plate 180 are emitted, so that the right eye 512 can view only the right eye image light and the left eye 514 can view only the left eye image light. Therefore, the viewer 500 can perceive the right eye image light and left eye image light as a stereoscopic image.

Hereinafter, a method for manufacturing the stereoscopic displaying apparatus 100 will be described. In the method for manufacturing the stereoscopic displaying apparatus 100 according to the present embodiment, the following steps are perforated in the described order: a first step of arranging the first polarizing region 181 and the second polarizing region 182 adjacent to each other on the phase shift plate 180; a second step of providing a light blocking section 190 that blocks the incident right eye image light and the left eye image light on the boundary between the first polarizing region 181 and the second polarizing region 182 on the one surface of the phase shift plate 180; and a third step of attaching to the image displaying section 130 the phase shift plate 180 such that one surface of phase shift plate 180 on which the light blocking section 190 is provided faces the image displaying section 130.

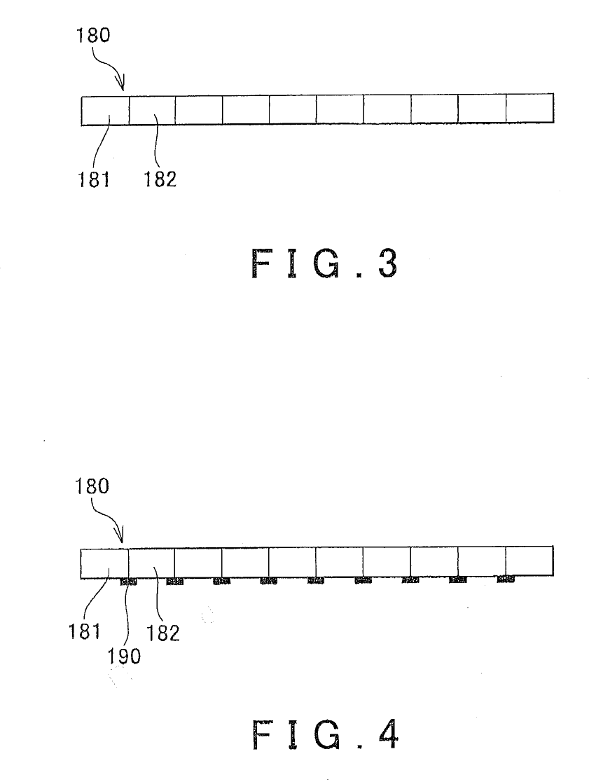

FIG. 3 is a schematic cross-sectional view showing a phase shift plate 180 at a time when the first step of the method for manufacturing the stereoscopic displaying apparatus 100 is completed. In the present step, the first polarizing regions 181 and the second polarizing regions 182 are alternately formed on the phase shift plate 180 which is formed of photopolymer, or which includes a transparent substrate with which the photopolymer is coated. Thereby the phase shift plate 180 is manufactured on which the first polarizing regions 181 and the second polarizing regions 182 are alternately arranged in adjacent to each other as shown in FIG. 3. Here, for the method for forming the first polarizing regions 181 and the second polarizing regions 182, well-known methods are appropriately selected.

FIG. 4 is a schematic cross-sectional view showing a phase shift plate 180 at a time when the second step of the method for manufacturing the stereoscopic displaying apparatus 100 is completed. In the present step, a strip light blocking section 190 is formed on the boundary between each first polarizing region 181 and each second polarizing region 182 on one surface of the phase shift plate 180 by screen pirating as shown in FIG. 4. Here, it is preferred that the light blocking section 190 is formed of material obtained by dispersing filer components in a binder resin. The filer components may be metal particles and the oxide thereof, or pigment and dye. It is preferred that the color tone of the filer components is black for the right eye image light and the left eye image light emitted from the image displaying section 130. The binder resin in which the pigment and the dye are dispersed or dissolved may be a well-known resin such as acrylic resin, methane resin, polyester, novolac resin, polyimide, epoxide resin, chloroethylene/vinyl acetate copolymer, nitrocellulose or these combination.

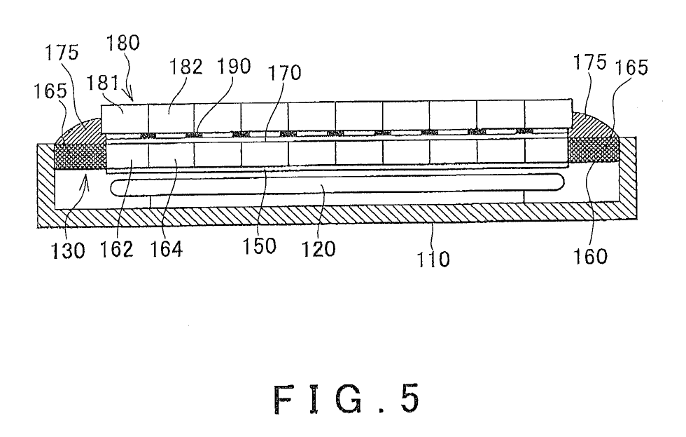

FIG. 5 is a schematic cross-sectional view showing the image displaying section 130 and the phase shift plate 180 at a time when the third step of the method for manufacturing the stereoscopic displaying apparatus 100 is completed. In the present step, firstly the phase shift plate 180 and the image displaying section 130 are arranged such that the surface of the phase shift plate 180 on which the light blocking sections 190 are provided faces the image displaying section 130. Here, the image displaying section 130 is attached to the housing 110 of which one surface is opened while the polarizing plate 150 and the polarizing plate 170 are previously attached to both surfaces of the image generating section 160 having the periphery on which the exterior frame 165 is provided, respectively as shown in FIG. 5. Here, the surface to which the polarizing plate 170 is attached is exposed to the outside from the opened surface. The housing 110 is made of such as plastic or stainless, and the light source 120 is fixed to the inside of the surface facing the opened surface. Moreover, an example of the image displaying section 130 is a LCD that displays a two-dimensional image without attaching the phase shift plate 180 in the present step.

The phase shift plate 180 and the image displaying section 130 are arranged as described above in the present step, so that one surface of the image displaying section 130 to which the polarizing plate 170 is attached faces the surface of the phase shift plate 180 on which the light blocking sections 190 are provided.

Next, after positioning the image displaying section 130 and the phase shift plate 180 with respect to the mutual facing direction such that each of the first polarizing regions 181 and each of the second polarizing regions 182 of the phase shift plate 180 face each of the right eye image generating regions 162 and each of the left eye image generating regions 164 of the image display section 130, respectively, the surface of the image display section 130 and that of the phase shift plate 180 which face each other are abutted.

Finally, the exterior frame 165 on the periphery of the image displaying section 130 and the side surface of the phase shift plate 180 are adhered with adhesive 175 as shown in FIG. 5. Thereby cross talk is less likely to occur in using the stereoscopic displaying apparatus 100. Here, after completing the present step, such as a diffuser panel or an anti-reflection film may be attached to the surface of the phase shift plate 180 which is exposed to the outside.

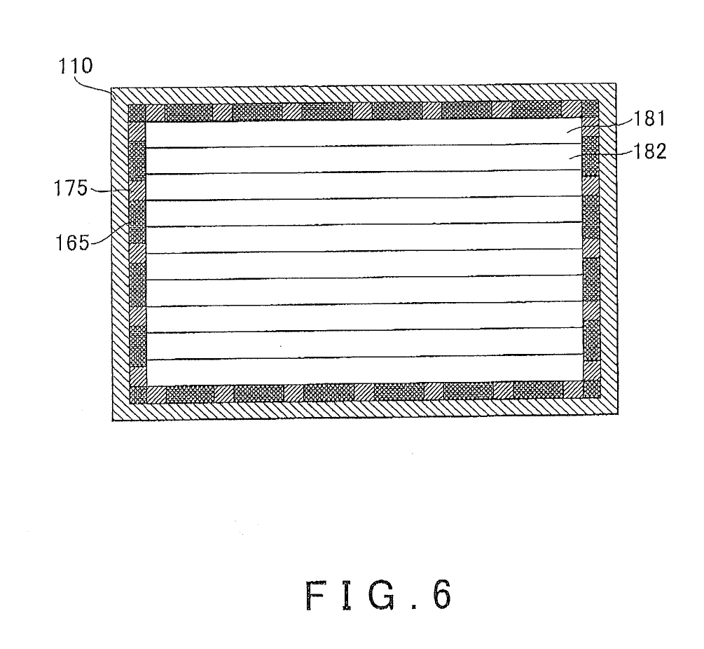

FIG. 6 is a schematic plan view showing the stereoscopic displaying apparatus 100 manufactured after the third step of the method for manufacturing the stereoscopic displaying apparatus 100 is completed. In the stereoscopic image displaying section 100, the exterior frame 165 of the image displaying section 130 is adhered to the side surface of the phase shift plate 180 at a plurality of adhering positions separated from each other with adhesive 175 as shown in FIG. 6 in the third step. Thereby heat generated from the image displaying section 130 can be effectively escaped in comparison with the case that all over the side surface of the phase shift plate 180 is coated with the adhesive 175 and attached to the exterior frame 165 of the image displaying section 130.

Here, the above described method for manufacturing the stereoscopic displaying apparatus 100 is not limited to the method including the above described steps 1-3. Hereinafter, another method for manufacturing the stereoscopic displaying apparatus 100 will be described. In the present method, the step 1 and the step 2 the same as those of the above described method; a third′ step of attaching to the image displaying section 130 the phase shift plate 180 such that one surface of the phase shift plate 180 on which the light blocking sections 190 are provided faces the image displaying section 130; and a fourth′ step of assembling the image displaying section 130 to which the phase shift plate 180 is attached and the housing 110 are performed in the described order.

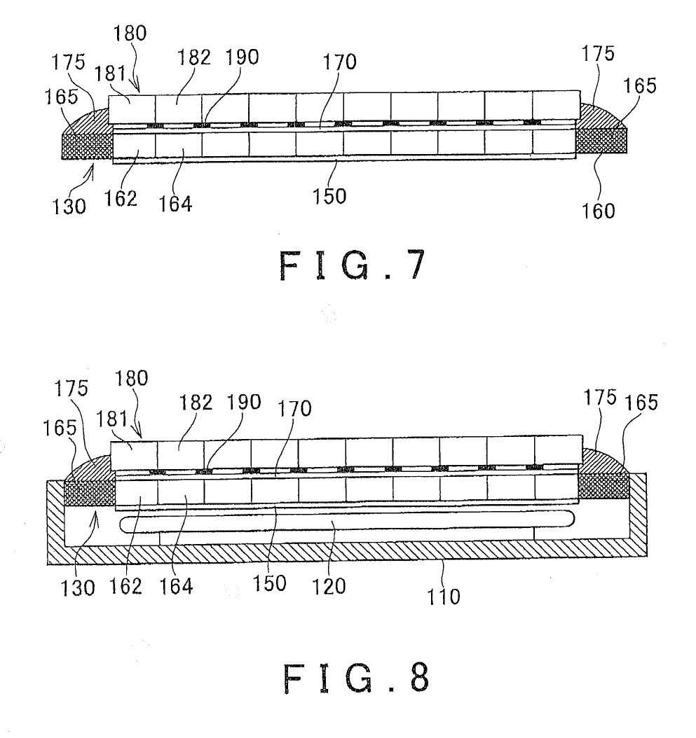

FIG. 7 is a schematic cross-sectional view showing the image displaying section 130 and the phase shift plate 180 at a time when the third′ step of the method for manufacturing the stereoscopic displaying apparatus 100 is completed. In the present step, firstly the phase shift plate 180 and the image displaying section 130 are arranged such that the surface of the phase shift plate 180 on which the light blocking sections 190 are provided faces the image displaying section 130. Here, one surface of the image displaying section 130 to which the polarizing plate 170 is attached faces the surface of the phase shift plate 180 on which the light blocking section 190 are provided while the polarizing plate 150 and the polarizing plate 170 are attached to both surfaces of the image generating section 160 having the periphery on which the exterior frame 165 is provided, respectively, as shown in FIG. 7. Next, after positioning the image displaying section 130 and the phase shift plate 180 with respect to the mutual facing direction such that each of the first polarizing regions 181 and each of the second polarizing regions 182 of the phase shift plate 180 face each of the right eye image generating regions 162 and each of the left eye image generating regions 164 of the image display section 130, respectively, the surface of the image display section 130 and that of the phase shift plate 180 which face each other are abutted. Finally, the exterior frame 165 on the periphery of the image displaying section 130 and the side surface of the phase shift plate 180 are adhered with adhesive 175 as shown in FIG. 7. Thereby cross talk is less likely to occur in using the stereoscopic displaying apparatus 100.

FIG. 8 is a schematic cross-sectional view showing the housing 110, the light source 120, the image displaying section 130 and the phase shift plate 180 at a time when the fourth′ step of the method for manufacturing the stereoscopic displaying apparatus 100 is completed. In the present step, the image displaying section 130 and the phase shift plate 180 which are positioned and adhered in the step 3′ are attached to the housing 110 of which one surface is opened such that the phase shift plate 180 is exposed to the outside from the opened surface as shown in FIG. 8. The housing 110 is made of such as plastic or stainless, and the light source 120 is fixed to the inside of the surface facing the opened surface. Moreover, the image displaying section 130 and the phase shift plate 180 are positioned on the housing 110 by screwing the exterior frame 165 of the image displaying section 130 on the side surface of the housing 110 in the present step. Here, after completing the preset step, such as a diffuser panel or an anti-reflection film may be attached to the surface of the phase shift plate 180 which is exposed to the outside.

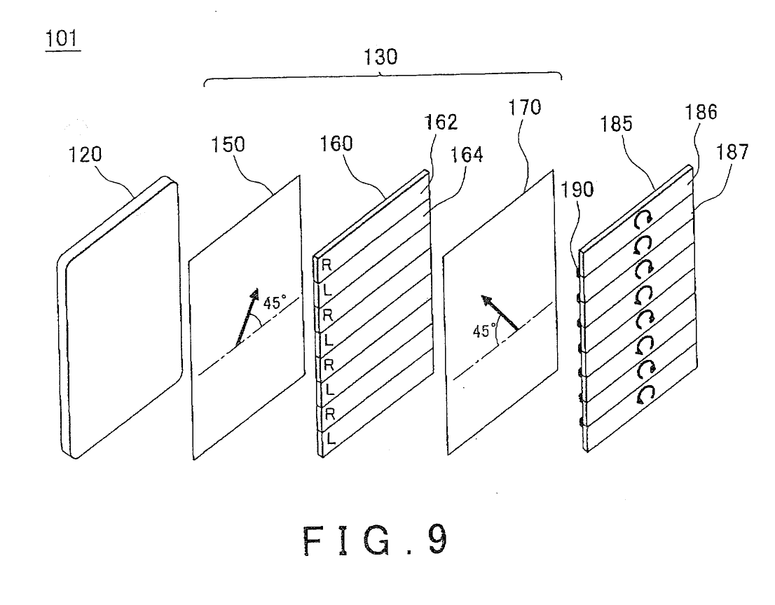

FIG. 9 is an exploded perspective view showing another stereoscopic displaying apparatus 101 manufactured by the method according to the present embodiment. The components of the stereoscopic displaying apparatus 101 shown in FIG. 9 the same as those of the stereoscopic displaying apparatus 100 have the reference numerals the same as those of the components of the stereoscopic displaying apparatus 100, so that the description is omitted. As shown in FIG. 9, the stereoscopic displaying apparatus 101 has a phase shift plate 185 instead of the phase shift plate 180 of the stereoscopic displaying apparatus 100. The phase shift plate 185 includes first polarizing regions 186 and second polarizing regions 187. Here, both of the first polarizing regions 186 and the second polarizing regions 187 are quarter wave retarders. The optical axis of each of them is orthogonalized to each other.

The position and the size for each of the first polarizing regions 186 and the second polarizing regions 187 in the phase shift plate 185 are corresponding to those for each of the right eye image generating regions 162 and the left eye image generating regions 164 of the image generating section 160 as well as the position and the size for each of the first polarizing regions 181 and the second polarizing regions 182 in the phase shift plate 180. Therefore, in using the stereoscopic displaying apparatus 101, the right eye image light transmitted through the right eye image generating region 162 is incident on the first polarizing region 186 and the left eye image light transmitted through the left eye image generating region 164 is incident on the second polarizing region 187.

In addition, the light blocking section 190 is provided on the boundary between each of the first polarizing regions 186 and each of the second polarizing regions 187 on the surface of the phase shift plate 185, which faces the image displaying section 130. The light blocking section 190 absorbs and blocks the image light over the boundary and incident on the first polarizing region 186 among the left eye image light to be incident on the second polarizing region 187 adjacent to the first polarizing region 186 in the phase shift plate 185. In the same way, the light blocking section 190 absorbs and blocks the image light over the boundary and incident on the second polarizing region 187 among the right eye image light to be incident on the first polarizing region 186 adjacent to the second polarizing region 187 in the phase shift plate 185. Thus, the light blocking section 190 is provided on each boundary on the phase shift plate 185, so that cross talk is less likely to occur in the right eye image light and the left eye image light emitted from the stereoscopic displaying apparatus 101.

The phase shift plate 185 emits the incident lights as circularly polarized lights of which polarization axes are rotated in the directions opposite to each other. For example, each of the first polarizing regions 186 emits the incident light as a clockwise circularly polarized light, and each of the second polarizing regions 187 emits the incident light as an anticlockwise circularly polarized light. Here, each arrow of the phase shift plate 185 shown in FIG. 8 indicates the rotating direction of the polarized light transmitted through the phase shift plate 185. For the first polarizing region 186, a quarter wave retarder of which optical axis is in the horizontal direction is used, and for the second polarizing region 187, a quarter wave retarder of which optical axis is in the vertical direction is used, for example.

Viewing the stereoscopic displaying apparatus 101 having the phase shift plate 185 shown in FIG. 8, the viewer 500 views with a polarized glasses (not shown in the figure) having the quarter wave retarder and the polarizing lens over the right eye 512 and the quarter wave retarder and the polarizing lens over the left eye 514, respectively. In the polarized glasses, the optical axis of the quarter wave retarder over the right eye 512 of the viewer 500 is in the horizontal direction, and the optical axis of the quarter wave retarder over the left eye 514 of the viewer 500 is in the vertical direction. Meanwhile, the transmission axis direction of each of the polarizing lens over the right eye 512 and the polarizing lens over the left eye 514 of the viewer 500 has the angle of 45 degree to the right from the viewpoint of the viewer 500, and the absorption axis direction is orthogonalized to the transmission direction.

In the case that the viewer 500 views the stereoscopic displaying apparatus 101 with the polarized glasses, when a circularly polarized light of which polarization axis is rotated clockwise from the view point of the viewer 500 is incident thereon, the circularly polarized light is transformed to a linear polarized light having the angle of 45 degree to the right by the quarter wave retarder of which optical axis is in the horizontal direction, transmitted through the polarizing lens and viewed by the right eye 512 of the viewer 500. Meanwhile, when a circularly polarized light of which polarization axis is rotated counterclockwise from the view point of the viewer 500 is incident thereon, the circularly polarized light is transformed to a linear polarized light having the angle of 45 degree to the right by the quarter wave retarder of which optical axis is in the vertical direction, transmitted through the polarizing lens and viewed by the left eye 514 of the viewer 500. Thus, the stereoscopic displaying apparatus 101 is viewed with the polarized glasses, so that the right eye 512 can view only the right eye image light and the left eye 514 can view only the left eye image light. Therefore, the viewer 500 can perceive the right eye image light and the left eye image light as a stereoscopic image.

Here, the entire size of the phase shift plate 180 may be larger or smaller than that of the image generating section 160 and the polarizing plate 170.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

As evidenced by the above description, the embodiments of the present invention provide the stereoscopic displaying apparatus 100 obtained by positioning the image displaying section 130 and the phase shift plate 180 with respect to the mutual facing direction and then adhering the periphery of the image displaying section 130 onto the side surface of the phase shift plate 180 with adhesive 175 at a plurality of adhering positions separated from each other, and the method of manufacturing the stereoscopic displaying apparatus 100. According to such stereoscopic displaying apparatus 100, the image displaying section 130 is adjacent to the phase shift plate 180, and the phase shift plate 180 has the light blocking section 190. Therefore, cross talk such that a part of the left eye image light from the left eye image generating region 164 of the image displaying section 130 is transmitted to the viewer through the right eye polarizing region of the phase shift plate 180 can be reduced. Moreover, the heat generated from the image displaying section can be efficiently escaped.

What is claimed is:

1. A method for manufacturing a stereoscopic displaying apparatus including: an image displaying section that has an image generating section including a right eye image generating region on which a right eye image is generated and a left eye image generating region on which a left eye image is generated and emits a right eye image light including the right eye image and a left eye image light including the left eye image as linear polarized lights of which polarization axes are in parallel with each other; and a phase shift plate having a first polarizing region and a second polarizing region, when the right eye image light is incident on the first polarizing region and the left eye image light is incident on the second polarizing region, respectively, that emits the incident right eye image light and left image light as linear polarized lights of which polarization axes are orthogonalized to each other or circularly polarized lights of which polarization axes are rotated in the directions opposite to each other,
the method for manufacturing the stereoscopic displaying apparatus comprising:
arranging the first polarizing region and the second polarizing region adjacent to each other on the phase shift plate;
providing a light blocking section that blocks the incident right eye image light and left eye image light on the boundary between the first polarizing region and the second polarizing region of one surface of the phase shift plate; and
attaching to the image displaying section the phase shift plate such that one surface of phase shift plate on which the light blocking section is provided faces the image displaying section,
wherein the step of attaching the phase shift plate to the image displaying section includes adhering a periphery outside the regions on which the phase shift plate is provided, which is one surface of the image displaying section from which the right eye image light and the left eye image light are emitted to a side surface adjacent to the incident surface of the phase shift plate on which the right eye image light and the left eye image light are incident with adhesive.

2. The method for manufacturing a stereoscopic displaying apparatus as set forth in claim 1, wherein the periphery of the image displaying section and the side surface of the phase shift plate are adhered at a plurality of adhering positions separated from each other with adhesive.

3. The method for manufacturing a stereoscopic displaying apparatus as set forth in claim 1, wherein the surface of the image displaying section from which the right eye image light and the left eye image light are emitted and the surface of the phase shift plate on which the light blocking section is provided are adhered in contact with each other.

4. A method for manufacturing a phase shift plate for use in the stereoscopic displaying apparatus that displays a stereoscopic image to a viewer, comprising:
arranging on the phase shift plate a first polarizing region and a second polarizing region adjacent to each other from which incident linear polarized lights of which polarization axes are in parallel with each other are emitted as linear polarized lights of which polarization axes are orthogonalized to each other or circularly polarized lights of which polarization axes are rotated in the directions opposite to each other; and
providing a light blocking section that blocks the incident linear polarized lights or circularly polarized lights on the boundary between the first polarizing region and the second polarizing region on one surface of the phase shift plate.

5. A phase shift plate for use in the stereoscopic displaying apparatus that displays a stereoscopic image to a viewer, comprising:
a first polarizing region and a second polarizing region adjacent to each other from which incident linear polarized lights of which polarization axes are in parallel with each other are emitted as linear polarized lights of which polarization axes are orthogonalized to each other or circularly polarized lights of which polarization axes are rotated in the directions opposite to each other; and
a light blocking section that blocks the incident linear polarized lights or circularly polarized lights on the boundary between the first polarizing region and the second polarizing region on one surface of the phase shift plate.
